(19) United States
(12) Patent Application Publication
(10) Pub. No.: US 2011/0134134 A1
(43) Pub. Date: Jun. 9, 2011

(54) IMAGE DISPLAY APPARATUS

(75) Inventor: Michio Yoshitake, Onga-gun (JP)

(73) Assignee: SEIKO EPSON CORPORATION, Tokyo (JP)

(21) Appl. No.: 12/970,308

(22) Filed: Dec. 16, 2010

(30) Foreign Application Priority Data
Dec. 6, 2009 (JP) 2009-285142

(51) Int. Cl. G09G 5/36

(52) U.S. Cl. 345/545

(57) ABSTRACT

An image display apparatus, including multiple line buffers that divide a unit line's worth of image data into multiple pieces and store those pieces. The compression unit, executes the first process in which the compression of the image data read out from the line buffer is carried out referring to image data of an adjacent pixel stored in the frame memory, and executes the second process, different from the first process, in the case where the read-out image data and the image data of the adjacent pixel are data from different line buffers. Accordingly, even if a plurality of line buffers that divide and store a unit line's worth of image data are provided, the writing of image data from the line buffers into the frame memory can be carried out efficiently.

### INCORPORATED BY REFERENCE

The entire disclosure of Japanese Patent Application No. 2009-285142, filed Dec. 16, 2009 is expressly incorporated by reference herein.

### BACKGROUND

1. Technical Field

The present invention relates to an image display apparatus that displays images in a display unit.

2. Related Art

In the past, an image display apparatus provided with a line buffer that temporarily holds one line's worth of image data and a VRAM (Video RAM) from and into which reading and writing are performed asynchronously has been proposed as this type of image display apparatus (for example, see JP-A-2002-55667). With this apparatus, image data read out from the line buffer is compressed and written into the VRAM, and the image data held in the VRAM is read out and decompressed through a predetermined cycle and outputted to a display device (LCD).

Incidentally, with an apparatus that is provided with two line buffers having capacities that are less than the data size of one line's worth of image data and that divides the one line's worth of image data and holds the divided data in the respective line buffers, it is necessary to write the image data from the multiple line buffers into a frame memory in a highly-efficient manner in order to maintain a comparatively high data transfer rate. Meanwhile, higher resolutions and higher numbers of tones continue to be implemented in recent displays, and when the resulting increase in image data amounts that must be handled is considered, it is desirable to compress the data as efficiently as possible and conserve as much space as possible in the frame memory.

### SUMMARY

An advantage of some aspects of the invention is to provide an image display apparatus, including multiple line buffers that divide a unit line's worth of image data into multiple pieces and store those pieces, that efficiently writes image data from the line buffers into a frame memory.

The image display apparatus according to the invention employs the following configuration in order to achieve the aforementioned advantage.

An image display apparatus according to an aspect of the invention is an image display apparatus that displays an image in a display unit, including: a plurality of line buffers that divide and store a unit line's worth of image data; a frame memory that stores a unit frame's worth of image data; a compression unit that, operating independently for each line buffer in the plurality of line buffers, sequentially reads out and compresses, one pixel at a time, the image data in the line buffer that is not prohibited from writing image data into the frame memory and writes the compressed image data into the frame memory; a decompression unit that sequentially reads out and decompresses the image data stored in the frame memory asynchronously from the compression unit, and that prohibits the writing of image data into the frame memory from the line buffer that conflicts with the readout; and a display output unit that outputs the decompressed image data to the display unit. The compression unit is a unit that executes a first process in which the compression of the image data read out from the line buffer is carried out referring to image data of an adjacent pixel stored in the frame memory, and executes a second process, different from the first process, in the case where the read-out image data and the image data of the adjacent pixel are data from different line buffers.

With the image display apparatus according to this aspect of the invention, the plurality of line buffers that divide and store a unit line's worth of image data and the frame memory that stores a unit frame's worth of image data are provided; the compression unit, operating independently for each line buffer in the plurality of line buffers, sequentially reads out and compresses, one pixel at a time, the image data in the line buffer that is not prohibited from writing image data into the frame memory and writes the compressed image data into the frame memory, whereas the decompression unit sequentially reads out and decompresses the image data stored in the frame memory asynchronously from the compression unit, and prohibits the writing of image data into the frame memory from the line buffer that conflicts with the readout. The compression unit, meanwhile, executes the first process in which the compression of the image data read out from the line buffer is carried out referring to image data of an adjacent pixel stored in the frame memory, and executes the second process, different from the first process, in the case where the read-out image data and the image data of the adjacent pixel are data from different line buffers. Accordingly, even if a plurality of line buffers that divide and store a unit line's worth of image data are provided, the writing of image data from the line buffers into the frame memory can be carried out efficiently.

In the image display apparatus according to the aforementioned aspect of the invention, the compression unit can be implemented as a unit that executes the first process even in the case where when the read-out image data and the image data of the adjacent pixel in the same frame are written into the frame memory, and the read-out image data and the image data of the adjacent pixel are data from different line buffers. This makes it possible to further improve the compression efficiency. Furthermore, the image display apparatus according to this aspect of the invention can be implemented so that the plurality of line buffers includes a first line buffer and a second line buffer whose pixel order is later than the first line buffer; the compression unit is a unit that sets a flag to a first state in the case where the writing of image data from the second line buffer into the frame memory for the same line is not prohibited and the writing of image data from the first line buffer into the frame memory is also not prohibited, and sets the flag to a second state in the case where the writing of image data from the second line buffer into the frame memory for the same line is not prohibited but the writing of image data from the first line buffer into the frame memory is prohibited; and the decompression unit is a unit that executes a decompression process that corresponds to the state of the flag that has been set.

Furthermore, in an image display apparatus according to an aspect of the invention, the first process can be implemented as a process to carry out compression based on a difference between the read-out image data and the image data of the adjacent pixel.

Furthermore, in an image display apparatus according to an aspect of the invention, the second process can be implemented as a process of no compression.

Furthermore, in an image display apparatus according to an aspect of the invention, the second process can be implemented as a process to carry out compression based on a difference between the read-out image data and predetermined data.

### BRIEF DESCRIPTION OF THE DRAWINGS

The invention will be described with reference to the accompanying drawings, wherein like numbers reference like elements.

FIG. 1 is a block diagram illustrating the overall configuration of a printer.

FIG. 2 is a block diagram generally illustrating an LCD controller.

FIG. 3 is a flowchart illustrating an example of a write process routine performed in a buffer.

FIG. 4 is a flowchart illustrating an example of a write process routine performed in a buffer.

FIG. 5 is a descriptive diagram illustrating the structure of compressed data within a VRAM.

FIG. 6 is a descriptive diagram illustrating a state of flags.

FIG. 7 is a flowchart illustrating an example of a frame decompression process routine.

FIG. 8 is a descriptive diagram illustrating reading/writing of data in a VRAM.

FIG. 9 is a descriptive diagram illustrating the structure of compressed data within a VRAM according to a variation.

FIG. 10 is a descriptive diagram illustrating the structure of compressed data within a VRAM according to a variation.

### DESCRIPTION OF EXEMPLARY EMBODIMENTS

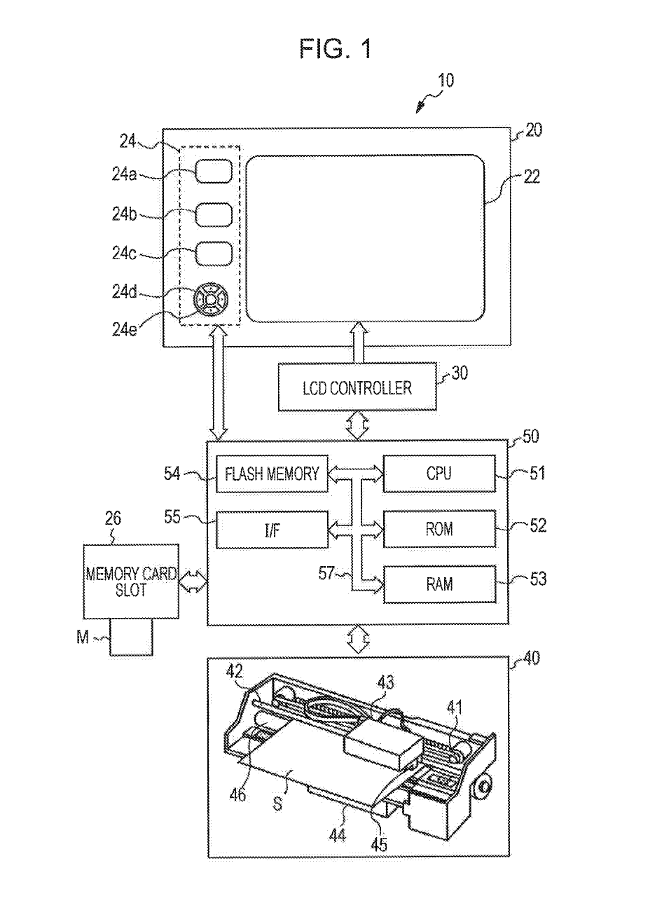

Hereinafter, an embodiment of the invention will be described based on the drawings. FIG. 1 is a block diagram illustrating the overall configuration of a printer 10 of an embodiment in the invention. As shown in FIG. 1, the printer 10 according to this embodiment includes an ink jet printing mechanism 40 having a print head 45 that ejects ink, an operation panel 20 that has a display 22, an LCD controller 30 that controls the display of the display 22, and a main controller 50 that controls the printer as a whole.

The printing mechanism 40 includes a carriage 43 that is driven by a carriage belt 41 provided in loop form in the left-right direction (the main scanning direction) and moves back and forth to the left and right along a guide 42; ink cartridges 44 that supply the carriage 43 with inks of various colors such as cyan, magenta, yellow, and black; the print head 45, which ejects the various inks supplied from the ink cartridges 44 toward recording paper S from nozzles by pressurizing the inks; and a transport roller 46 that transports the recording paper S in the sub scanning direction. The ink cartridges 44 are what is known as the “off-carriage type”, where the ink cartridges 44 are attached to the bottom of the printing mechanism 40 rather than being mounted upon the carriage 43. Here, the print head 45 employs a system of pressurizing the ink by applying a voltage to piezoelectric elements and causing the piezoelectric elements to deform; however, a system in which a voltage is applied to heat resistors (for example, heaters or the like), the ink is heated, and the ink is then pressurized using foam generated in the ink may be employed instead.

The operation panel 20 includes the display 22, serving as a liquid-crystal display (LCD) that displays text, figures, symbols, and so on, and buttons 24 disposed adjacent to the display 22. In this embodiment, the display 22 is configured of 960×240 dot pixels, where one line is formed of 960 dots' worth of image data, and one frame (one image) is formed of 240 lines' worth of line data. The buttons 24 include: a power button 24a for turning the power on and off; a display switch button 24b for switching the display size of images or the like displayed in the display 22 between a six split-screen display, a 15 split-screen display, a full-screen display, or the like; a print button 24c for instructing printing to be executed onto the recording paper S; an up-down-left-right button 24d manipulated when selecting a desired selection. from multiple selections displayed in the display 22, moving a cursor, and so on; an OK button 24e, disposed in the center of the up-down-left-right button 24d, for instructing a selection made using the up-down-left-right button 24d to be accepted; and so on.

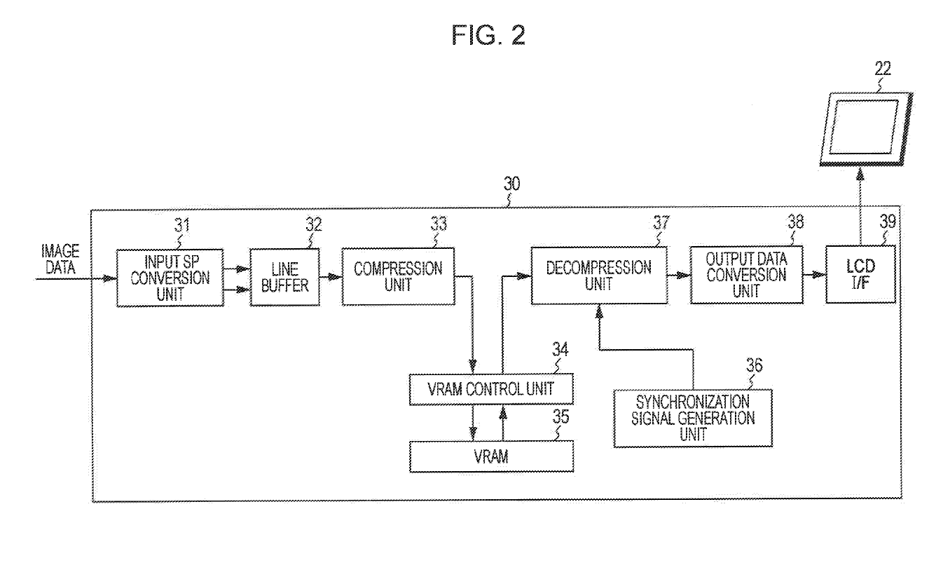

The display 22 displays screens under the control of the LCD controller 30. FIG. 2 is a block diagram illustrating the overall configuration of the LCD controller 30. As shown in FIG. 2, the LCD controller 30 includes: an input SF conversion unit 31 that converts inputted image data that is serial data into image data that is parallel data; a line buffer 32 that temporarily holds one line's worth of the image data that has been converted into parallel data; a compression unit 33 that reads out and compresses one pixel at a time of the image data from the line buffer 32; a VRAM 35 that holds one framers worth of compressed data; a VRAM control unit 34 that controls the writing of compressed data into the VRAM 35 and the reading out of compressed data that is held in the VRAM 35; a synchronization signal generation unit 36 that generates various types of synchronization signals such as horizontal/vertical synchronization signals; a decompression unit 37 that restores the original image data by cyclically reading out the compressed data from the VRAM 35 in synchronization with the horizontal/vertical synchronization signals for displaying screens in the display 22 and decompressing that read-out data; an output data conversion unit 38 that converts the restored image data for display in the display 22; and an LCD interface (I/F) 39 connected to the display 22.

The line buffer 32 is configured of two line buffers BL0 and BL1, which in turn are configured of, for example, 429-word×24-bit SRAMs (static RAMs), and one line's worth of image data is held, in order from the left to the right direction of the image, in the two line buffers BL0 and BL1. In this embodiment, the left half (left image) of the one line's worth of image data is held in the line buffer BL0, whereas the light half (right image) is held in the line buffer BL1.

The readout of the compressed data from the VRAM 35 commences as a result of the decompression unit 37 making an instruction to the VRAM control unit 34 when a horizontal synchronization signal has been outputted from the synchronization signal generation unit 36, and one line's worth of compressed data is read out in order from the left to the right direction of the image during the single cycle spanning until the next horizontal synchronization signal is outputted. Furthermore, the readout of the compressed data is carried out one pixel. at a time based on a clock signal, outputted from the synchronization signal generation unit 36, that defines the readout timing of the one pixel's worth of compressed data. On the other hand, the writing of the compressed data into the VRAM 35 is carried out asynchronously from the aforementioned readout of the compressed data (that is, from the horizontal synchronization signal), and is carried out as a result of the compression unit 33 making an instruction to the VRAM control unit 34. To be more specific, this writing is commenced at the timing at which the one line's worth of image data is stored in the line buffer 32 (the line buffers BL0 and BL1), and is carried out by reading out the image data from the line buffer 32 one pixel at a time from the left to the right direction in the image, compressing that data, and writing the compressed data into the VRAM 35. In this embodiment, the image data is read out from the two line buffers BL0 and BL1 separately, and is then written into the VRAM 35 as compressed data. Accordingly, when the left half of one line of an image is held in the line buffer BL0, that image data is written into the VRAM 35 independent of the line buffer BL1, and when the right half of one line of an image is held in the line buffer BL1, that image data is written into the VRAM 35 independent of the line buffer BL0. As described above, the readout of the compressed data from the VRAM 35 and the writing of the compressed data into the VRAM 35 are carried out asynchronously, and thus cases occur in which the writing of new compressed data surpasses the readout of compressed data in the same line or the readout of compressed data surpasses the writing of new compressed data into the VRAM 35 in the same line (that is, readout and writing conflict with each other). in this embodiment, periods in which such surpassing may occur are set to be “write prohibited periods”, in which the writing of compressed data into the VRAM 35 is prohibited. Furthermore, in this embodiment, because data is read out from and written into the two line buffers BL0 and BL1 independently from each other, the write prohibited periods for the respective line buffers are set to occur at different timings. Accordingly, there are cases where the timing at which the left image is written into the VRAM 35 from the line buffer BL0 and the timing at which the right image is written into the VRAM 35 from the line buffer BL1 are switched, even when the left image is held in the line buffer BL0 and the right image is held in the line buffer BL1.

The controller 50 is configured as a microprocessor that is centered around a CPU 51, and includes a ROM 52 that stores various types of processing programs, various types of data, various types of tables, and so on, a RAM 53 that temporarily stores data, a flash memory 54 that can be electrically rewritten and that holds data even when the power thereto has been turned off, and an interface 55 (I/F) capable of communicating with a memory card M that has been inserted into a memory card slot 26, the printing mechanism 40, and the operation panel 20; these elements are connected to each other via a bus 57 so as to be capable of exchanging signals with each other. The controller 50 inputs image files and the like into the memory card M that has been inserted into the memory card slot 26, and inputs instructional signals from the button group 24 of the operation panel 20, detection signals from the various elements of the printing mechanism 40, and so on. Furthermore, in addition to saving edited images in the memory card M, the controller 50 also outputs control signals to the various elements of the printing mechanism 40, control signals to the display 22 of the operation panel 20, and so on.

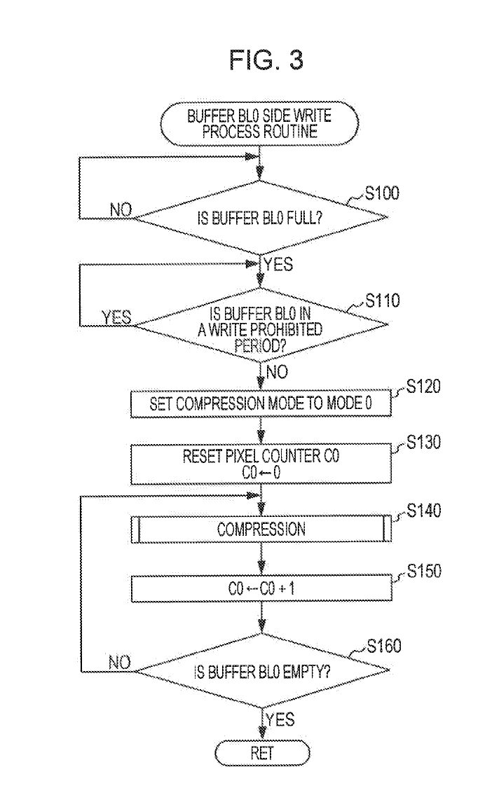

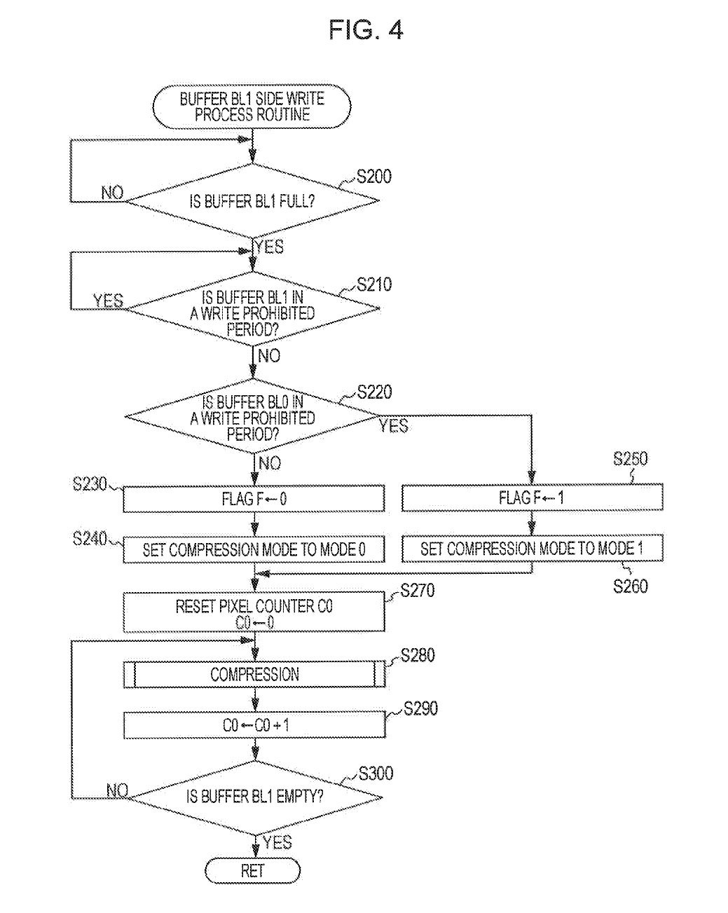

Next, operations performed by the printer 10 configured in this manner, and particularly operations performed when compressing image data from the line buffer 32 and writing that compressed data into the VRAM 35 and operations performed when reading out and decompressing the compressed data from the VRAM 35, will be described. First, the former operations will be described, and then the latter operations will be described. FIG. 3 is a flowchart illustrating an example of a buffer BL0 side write process routine executed by the compression unit 33, whereas FIG. 4 is a flowchart illustrating an example of a buffer BL1 side write process routine executed by the compression unit 33. These routines are executed in parallel.

When the buffer BL0 side write process routine is executed, first, the apparatus waits until the entirety of the left half of one line of image data is held in the line buffer BL0 (step S100), after which it is determined whether or not the writing of data into the VRAM 35 from the line buffer BL0 is prohibited (that is, whether it is currently a write prohibited period) (step S110). Here, the prohibition of writing is carried out by the decompression unit 37 when the writing of the left image compressed data into the VRAM 35 from the line buffer BL0 performed by the compression unit 33 and the readout of the left image compressed data of the same line by the decompression unit 37 will conflict. When it is currently a write prohibited period, the apparatus stands by as-is, whereas when it is not currently a write prohibited period, the compression mode is set to a mode 0 (step S120), and a pixel counter C0 is reset to a value of 0 (step S130). Then, the image data is read out starting with the address (pixel) of the line buffer BL0 indicated by the pixel counter C0, and the image data is compressed according to the mode 0 (step S140). Next, the value of the pixel counter C0 is incremented by 1 (step S150), after which it is determined whether or not the line buffer BL0 is empty (step S160); when the line buffer BL0 is not empty, the routine returns to step S140 and the process for reading out image data from the line buffer BL0 and compressing the image data is repeated from the next pixel, whereas when the line buffer BL0 is empty, the routine ends. The mode 0 compression mode is, in this embodiment, a mode that performs no compression on a leading pixel indicated by a pixel counter C0 value of 0, and that compresses the second pixel to the last pixel, indicated by a pixel counter C0 value of 1, by calculating the difference between the image data of the pixel in question and the image data of the pixel that is adjacent thereto on the left (that is, the image data that was compressed one pixel previously) and quantizing that calculated difference (that is, DPCM encoding), Note that when the image data of a pixel indicated by the pixel counter C0 is read out through step S140, the read-out image data is temporarily held, and this image data is used in the compression. of the image data of the next pixel indicated by the pixel counter C0, obtained by adding a value of 1 to the held image data.

Next, the buffer BL1 side write process routine will be described. When the buffer BL1 side write process routine is executed, first, the apparatus waits until the entirety of the right half of one line of image data is held in the line buffer BL1 (step S200), after which it is determined whether or not the writing of data into the VRAM 35 from the line buffer BL1 is prohibited (that is, whether it is currently a write prohibited period) (step S210). Here, the prohibition of writing is carried out by the decompression unit 37 when the writing of the right image compressed data into the VRAM 35 from the line buffer BL1 performed by the compression unit 33 and the readout of the right image compressed data of the same line by the decompression unit 37 will conflict. When it is currently a write prohibited period, the apparatus stands by as-is, whereas when the line buffer BL1 is not currently in a write prohibited period, it is then determined whether or not the line buffer BL0, which holds the left half of the one line of image data, is currently in a write prohibited period (step S220). When the line buffer BL0 is not in the write prohibited period, a flag F is set to a value of 0 (step S230) and the compression mode is set to the aforementioned mode 0 (step S240), whereas when the line buffer BL0 is in the write prohibited period, the flag F is set to a value of 1 (step S250) and the compression mode is set to a mode 1 (step S260). Here, a value of 0 for the flag F indicates that the timing of the writing of the left image is earlier than the timing of the writing of the right image, whereas a value of 1 for the flag F indicates that the timing of the writing of the right image is earlier than the timing of the writing of the left image. Next, the pixel counter C0 is reset to a value of 0 (step S270), and the image data is read out starting with the address (pixel) of the line buffer BL1 indicated by the pixel counter C0; the read-out image data is then compressed according to the compression mode set in step S240 or step S260 (step S280). Then, the value of the pixel counter C0 is incremented by 1 (step S290), after which it is determined whether or not the line buffer BL1 is empty (step S300); when the line buffer BL1 is not empty, the routine returns to step S280 and the process for reading out image data from the line buffer BL0 and compressing the image data is repeated from the next address (pixel), whereas when the line buffer BL1 is empty, the routine ends. Here, the mode 1 compression mode is a mode that compresses the leading pixel, indicated by a pixel counter C0 value of 0, by performing the aforementioned DPCM encoding based on the difference between the image data of the pixel in question and the image data of the last pixel from the line buffer BL0, and that compresses the second pixel to the last pixel, indicated by a pixel counter C0 value of 1, by performing DPCM encoding based on the difference between the image data of the pixel in question and the image data of the pixel that is adjacent thereto on the left (that is, the image data that was compressed one pixel previously), as with the compression according to the mode 0. Note that the pre-compression image data saved during the buffer BL0 side write process routine can be used as the image data of the final pixel from the line buffer BL0.

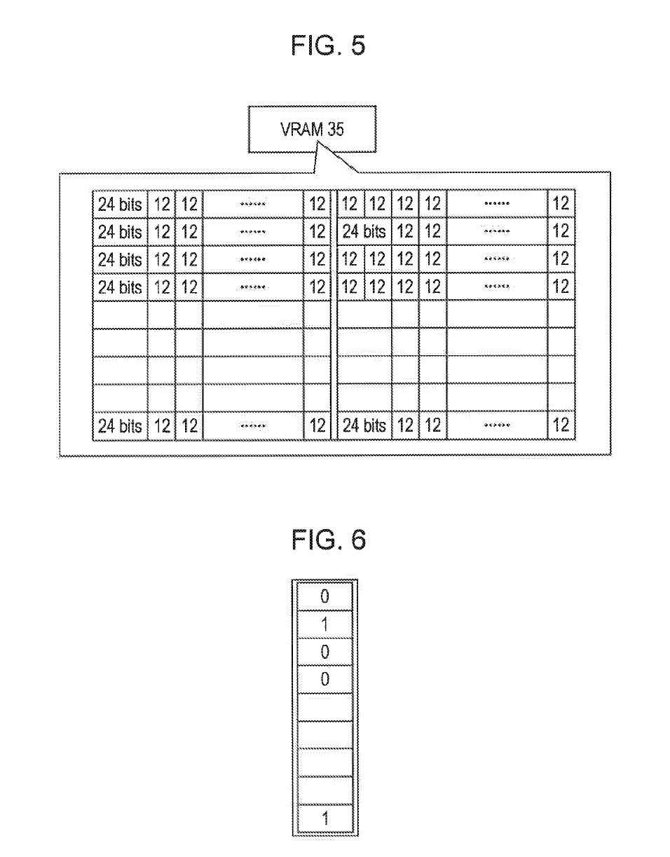

FIG. 5 illustrates the structure of compressed data within the VRAM 35, whereas FIG. 6 indicates the state of the flag F. In this embodiment, the image data is expressed as 8-bit values for each of R, G, and B luminosity levels, and assuming that the DPCM encoding quantization is carried out at 4 bits, the uncompressed data has a data size of 24 bits, whereas the data compressed according to the DPCM encoding has a data size of 12 bits. As illustrated in FIGS. 5 and 6, when the right image compressed data is written into the VRAM 35 from the line buffer BL1 before the left image compressed data is written into the VRAM 35 from the line buffer BL0 in the same line while the line buffer BL0 is in the write prohibited period (that is, when the flag F has a value of 1), the compressed data of the final pixel in the left image has not yet been written and the compression according to DPCM encoding cannot be carried out as a result, and thus the data remains uncompressed; however, when the right image compressed data is written into the VRAM 35 from the line buffer BL1 after the left image compressed data has been written into the VRAM 35 from the line buffer BL0 when the line buffer BL0 is not in the write prohibited period (that is, the flag F has a value of 0), the compressed data of the final pixel of the left image has already been written, and thus the compression according to DPCM encoding is carried out. This makes it possible to increase the compression efficiency more than that when the data of the leading pixel in the right image is always left uncompressed.

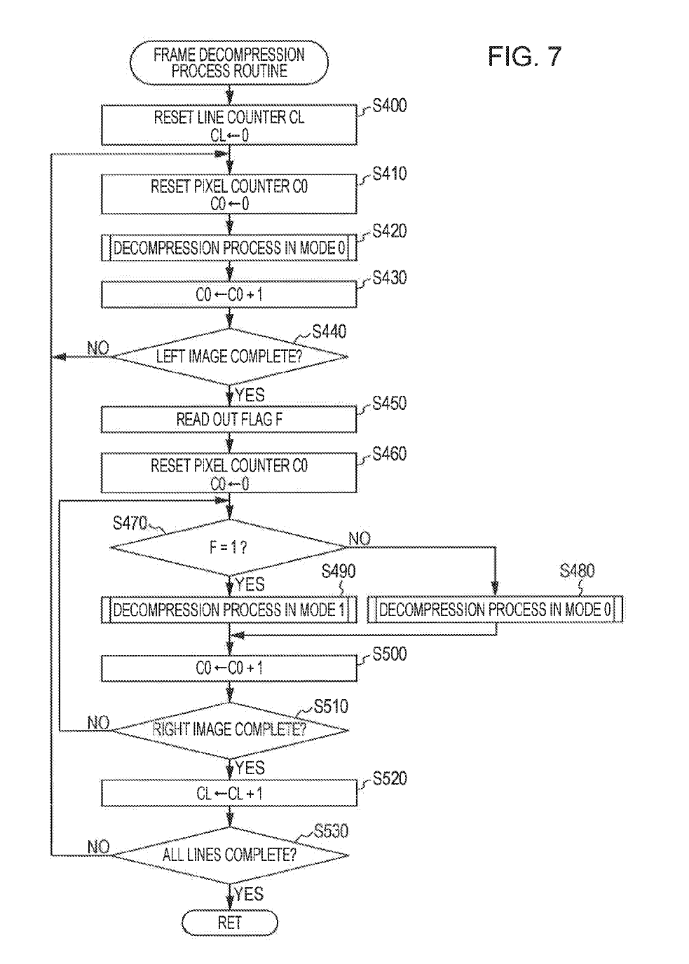

Next, a frame decompression process will be described. FIG. 7 is a flowchart illustrating an example of a frame decompression process routine. When the frame decompression process is executed, first, a line counter CL is reset to a value of 0 (step S400), after which the pixel counter C0 is reset to a value of 0 (step S410). Then, the compressed data of the address (pixel) in the VRAM 35 indicated by the pixel counter C0 is read out, and the compressed data is decompressed according to the mode 0 (step S420); then, the value of the pixel counter C0 is incremented by 1 (step S430), and the routine returns to S410 and the processing is repeated until the readout of the left image compressed data is complete. When the readout of the left image compressed data is complete, the flag F is read out (step S450) and the pixel counter C0 is reset to a value of 0 (step S460); when the flag F has a value of 0 (step S470), it is determined that the timing of the writing of the left image is earlier than the timing of the writing of the right image in the same line in the VRAM 35 and that the compressed data has been compressed according to the mode 0, and thus the decompression process is executed according to the mode 0 (step S480), whereas when the flag F has a value of 1 (step S470), it is determined that the timing of the writing of the right image is earlier than the timing of the writing of the left image in the same line in the VRAM 35 and that the compressed data has been compressed according to the mode 1, and thus the decompression process is executed according to the mode 1 (step S490). Then, the pixel counter C0 is incremented by 1 (step S500), and the routine returns to S470 and the processing is repeated until the readout of the right image compressed data is completed (step S510). When the readout of the right image compressed data is complete, the line counter CL is incremented by 1 (step S520), and the routine returns to S410 and the processing is repeated from steps S410 to S510 until the readout of the compressed data in all of the lines is complete (step S530); when the readout of the compressed data in all of the lines is complete, the routine ends.

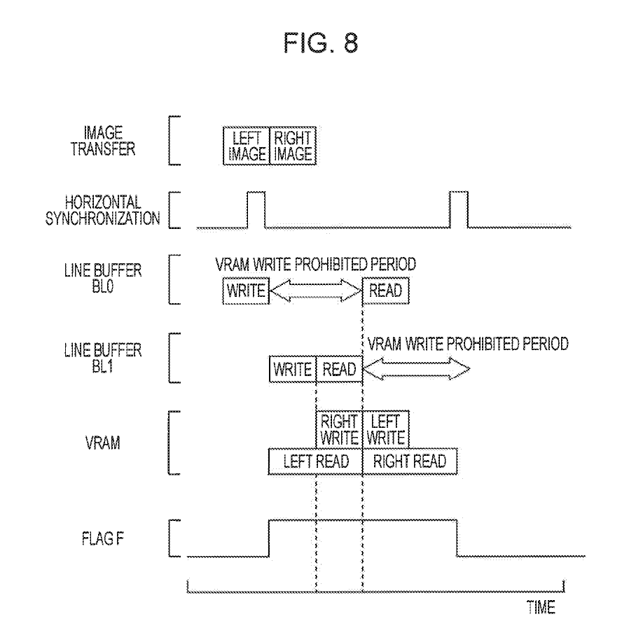

FIG. 8 illustrates the reading/writing of data into a VRAM. As shown in FIG. 8, when the left half (left image) of one line's worth of image data is held in the line buffer BL0 and the right half (right image) of the one line's worth of image data is held in the line buffer BL1, the image data is read out from the line buffer BL1, compressed, and written into the VRAM 35 earlier than the line buffer BL0 when the left image in the same line of the VRAM 35 is being read out and the line buffer BL0 is in the write prohibited period. When the readout of the left image from the VRAM 35 is completed and the line buffer BL0 is no longer in the write prohibited period, the image data is read out from the line buffer BL0, compressed, and written into the VRAM 35 after the line buffer BL1. As described earlier, the compression of the image data is carried out based on the difference between the image data of the pixel in question and the image data of the pixel that is adjacent to the left thereof, and because the pixel that is adjacent to the left of the leading pixel in the right image is the final pixel in the left image, the image data of the leading pixel in the right image is written into the VRAM 35 in an uncompressed state in the situation described above.

Here, the correspondence relationships between the constituent elements of this embodiment and the constituent elements of the invention will be clarified. The line buffers BL0 and BL1 according to this embodiment correspond to “a plurality of line buffers” according to the invention; the VRAM 35 corresponds to a “frame memory”; the compression unit 33 corresponds to a “compression unit”; the decompression unit 37 corresponds to a “decompression unit”; and the output data conversion unit 38 corresponds to a “display output unit”.

According to the printer 10 in the aforementioned embodiment, the line buffer 32 is configured of the two line buffers BL0 and BL1 that respectively hold the left half (left image) and right half (right image) of one line's worth of image data and that operate independently in write prohibited periods set so that the readouts of data from the VRAM 35 to those line buffers do not conflict with each other, and in the case where the line buffer BL0 is in a write prohibited period and the data of the right image is written into the VRAM 35 from the line buffer BL1 before the data of the left image in the same line is written into the VRAM 35 from the line buffer BL0, the leading pixel of the right image is not compressed and the second and successive pixels are compressed based on the difference between the image data of the pixel in question and the image data of the pixel one place previous (that is, the pixel that is adjacent to the left), whereas in the case where the line buffer BL0 is not in the write prohibited period and the data of the right image is written into the VRAM 35 from the line buffer BL1 after the data of the left image in the same line is written into the VRAM 35 from the line buffer BL0, the leading pixel of the right image is compressed based on the difference between the image data of that pixel and the image data of the final pixel in the left image, which is the pixel that is adjacent to the left, and the second and successive pixels are compressed based on the difference between the image data of the pixel in question and the image data of the pixel one place previous (that is, the pixel that is adjacent to the left); accordingly, the writing of data into the VRAM 35 from the line buffer 32 can be carried out efficiently and the compression efficiency can be increased as well.

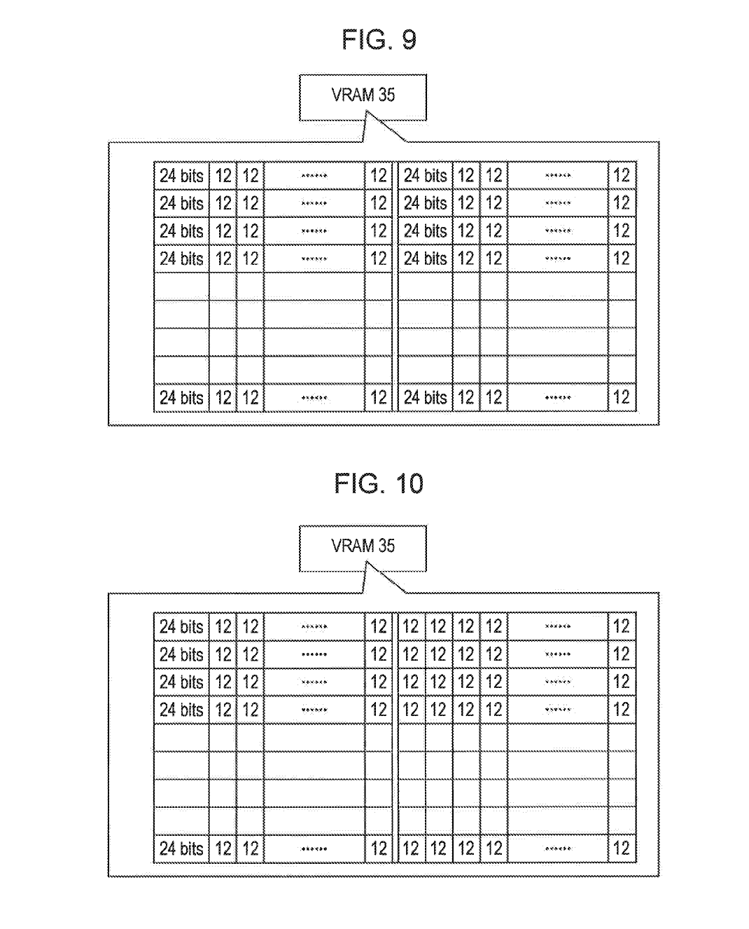

In the aforementioned embodiment, with respect to data compression for the leading pixel in the right image, that leading pixel is not compressed in the case where the data of the right image is written into the VRAM 35 from the line buffer BL1 before the data of the left image is written into the VRAM 35 from the line buffer BL0, whereas the leading pixel is compressed based on the difference between the image data of that pixel and the image data of the final pixel in the left image, which is the pixel that is adjacent to the left, in the case where the data of the right image is written into the VRAM 35 from the line buffer BL1 after the data of the left image is written into the VRAM 35 from the line buffer BL0; however, no compression may be used in both cases, or the compression may be carried out through DPCM encoding based on the difference from a predetermined fixed value instead of the image data of the final pixel in the left image. The structure of the compressed data in the VRAM 35 in the former case is illustrated in FIG. 9, whereas the structure of the compressed data in the VRAM 35 in the latter case is illustrated in FIG. 10.

Although the aforementioned embodiment being describe not compressing the data of the leading pixel in the left image, the invention is not limited thereto, and this pixel may be compressed through DPCM encoding based on a difference from a predetermined fixed value.

Although the aforementioned embodiment describes the invention as being applied in the printer 10, which includes a liquid crystal display, the invention is not limited thereto, and can be applied in any device that includes a display, such as a fax machine, a viewer, a personal computer, or the like. Furthermore, the display is not limited to a liquid crystal display, and the invention can be applied in any display that is configured of multiple pixels, such as a plasma display, an organic EL display, or the like.

Note that the invention is not intended to be limited in any way to the foregoing embodiment, and it goes without saying that the invention can be carried out in various forms within the technical scope thereof.

What is claimed is:

1. An image display apparatus that displays an image in a display unit, the apparatus comprising:
a plurality of line buffers that divide and store a unit line's worth of image data;
a frame memory that stores a unit frame's worth of image data;
a compression unit that, operating independently for each line buffer in the plurality of line buffers, sequentially reads out and compresses, one pixel at a time, the image data in the line buffer that is not prohibited from writing image data into the frame memory and writes the compressed image data into the frame memory;
a decompression unit that sequentially reads out and decompresses the image data stored in the frame memory asynchronously from the compression unit, and that prohibits the writing of image data into the frame memory from the line buffer that conflicts with the readout; and
a display output unit that outputs the decompressed image data to the display unit,
wherein the compression unit is a unit that executes a first process in which the compression of the image data read out from the line buffer is carried out referring to image data of an adjacent pixel stored in the frame memory, and executes a second process, different from the first process, in the case where the read-out image data and the image data of the adjacent pixel are data from different line buffers.

2. The image display apparatus according to claim 1, wherein the compression unit is a unit that executes the first process even in the case where when the read-out image data and the image data of the adjacent pixel in the same frame are written into the frame memory, and the read-out image data and the image data of the adjacent pixel are data from different line buffers.

3. The image display apparatus according to claim 2,
wherein the plurality of line buffers includes a first line buffer and a second line buffer whose pixel order is later than the first line buffer;
the compression unit is a unit that sets a flag to a first state in the case where the writing of image data from the second line buffer into the frame memory for the same line is not prohibited and the writing of image data from the first line buffer into the frame memory is also not prohibited, and sets the flag to a second state in the case where the writing of image data from the second line buffer into the frame memory for the same line is not prohibited but the writing of image data from the first line buffer into the frame memory is prohibited; and
the decompression unit is a unit that executes a decompression process that corresponds to the state of the flag that has been set.

4. The image display apparatus according to claim 1, wherein the first process is a process to carry out compression based on a difference between the read-out image data and the image data of the adjacent pixel.

5. The image display apparatus according to claim 1, wherein the second process is a process of no compression.

6. The image display apparatus according to claim 1, wherein the second process is a process to carry out compression based on a difference between the read-out image data and predetermined data.
